(19) United States
(12) Patent Application Publication
(10) Pub. No.: US 2014/0071035 A1
(43) Pub. Date: Mar. 13, 2014

(54) LIQUID CRYSTAL DISPLAY AND SHIFT REGISTER DEVICE THEREOF

(71) Applicant: HANNSTAR DISPLAY CORPORATION, New Taipei City (TW)

(72) Inventors: Chia-Hua Yu, New Taipei City (TW); Sung-Chun Lin, Tainan City (TW); Hsuan-Chen Liu, Kaohsiung City (TW); Chien-Ting Chan, Tainan City (TW)

(73) Assignee: HANNSTAR DISPLAY CORPORATION, New Taipei City (TW)

(21) Appl. No.: 13/794,807

(22) Filed: Mar. 12, 2013

(30) Foreign Application Priority Data
Sep. 7, 2012 (CN) 201210329863.4

(51) Int. Cl. G09G 3/36

(52) U.S. Cl. CPC G09G 3/3648
USPC 345/100

(57) ABSTRACT

A liquid crystal display and a shift register device thereof are provided. The shift register device includes a plurality of shift registers connected in series, where an i^{th} shift register includes a main circuit and a trimming circuit. The main circuit is configured to generate a scan signal in response to a first through a third predetermined clock signals. The trimming circuit is coupled to the main circuit, and is configured to perform a trimming operation on the generated scan signal in response to a part of the first through the third predetermined clock signals and a fourth predetermined clock signal. Accordingly, the feed through effect may be reduced, thereby reducing flickers on a displayed image.

### CROSS-REFERENCE TO RELATED APPLICATION

This application claims the priority benefit of China application serial no. 201210329863.4, filed on Sep. 7, 2012. The entirety of the above-mentioned patent application is hereby incorporated by reference herein and made a part of this specification.

### TECHNICAL FIELD

The invention relates to a flat panel display technique, and more particularly, to a liquid crystal display and a shift register device thereof.

### BACKGROUND

In recent years, following the advance in the semiconductor technique, portable electronic devices and flat panel displays have been rapidly developed. Among various types of flat panel display, liquid crystal displays (LCDs) have gradually become the mainstream display products due to the advantages such as low operating voltage, free of harmful radiation, light-weight, small, compact size and so on.

With regard to active matrix liquid crystal display (AMLCD), when an active element (namely, a thin film transistor) of each pixel enters a turn-off status from a turn-on status in response to a corresponding scan signal, the voltage on a corresponding pixel electrode may be affected by the parasitic capacitance between electrodes in the active element, and may be decreased by a voltage difference (ΔV), where the voltage difference is generally referred to as a feed-through voltage, and such phenomenon may be referred to as a feed through effect, thereby causing the liquid crystal display panel to generate flickers on a displayed image.

### SUMMARY

Accordingly, in order to solve the issues/problems mentioned in the background, an exemplary embodiment of the invention provides a shift register device including a plurality of shift registers connected in series, wherein an i^{th} shift register includes a main circuit and a trimming circuit, where i is a positive integer. The main circuit is configured to generate a scan signal in response to a first through a third predetermined clock signals. The trimming circuit is coupled to the main circuit, and is configured to perform a trimming operation on the scan signal in response to a part of the first through the third predetermined clock signals and a fourth predetermined clock signal.

According to an exemplary embodiment of the invention, the main circuit of the i^{th} shift register includes a pre-charge unit, a pull-up unit and a pull-down unit. Wherein, the pre-charge unit is configured to receive a first start pulse signal or an output of an (i−1)^{th} shift register, and accordingly output a charge signal. The pull-up unit is coupled to the pre-charge unit, and is configured to receive the charge signal and the first predetermined clock signal, and accordingly output the scan signal. The pull-down unit is coupled to the pre-charge unit, the pull-up unit and the trimming circuit, and is configured to receive the second predetermined clock signal, the third predetermined clock signal, an output of an (i+2)^{th} shift register and one of a second start pulse signal and the scan signal, and accordingly determine whether to pull down the scan signal to a reference level.

According to an exemplary embodiment of the invention, the pre-charge unit of the i^{th} shift register includes a first transistor. Wherein, a gate and a drain of the first transistor are coupled with each other to receive the first start pulse signal or the output of the (i−1)^{th} shift register, and a source of the first transistor outputs the charge signal.

According to an exemplary embodiment of the invention, the pull-up unit of the i^{th} shift register includes a second transistor, a third transistor and a first capacitor. Wherein, a gate of the second transistor is coupled to the source of the first transistor, a drain of the second transistor receives the first predetermined clock signal, and a source of the second transistor outputs the scan signal. A gate and a source of the third transistor are coupled to the source of the second transistor, and a drain of the third transistor receives the first predetermined clock signal. The first capacitor is coupled between the gate and the source of the second transistor.

According to an exemplary embodiment of the invention, the pull-down unit of the i^{th} shift register includes a fourth transistor, a fifth transistor and a sixth transistor. Wherein, a gate of the fourth transistor receives the second predetermined clock signal, a drain of the fourth electrode is coupled to the source of the second transistor, and a source of the fourth transistor is coupled to the reference level. A gate of the fifth transistor receives the third predetermined clock signal, a drain of the fifth transistor receives the second start pulse signal or the scan signal, and a source of the fifth transistor is coupled to the source of the first transistor. A gate of the sixth transistor receives the output of the (i+2)^{th} shift register, a drain of the sixth transistor is coupled to the source of the first transistor, and a source of the sixth transistor is coupled to the reference level.

According to an exemplary embodiment of the invention, the trimming circuit of the i^{th} shift register includes a second capacitor, a seventh transistor and an eighth transistor. Wherein, a first terminal of the second capacitor receives the fourth predetermined clock signal. A gate of the seventh transistor is coupled to a second terminal of the second capacitor, a drain of the seventh transistor is coupled to the source of the second transistor, and a source of the seventh transistor is coupled to the reference level. A gate of the eighth transistor receives the second predetermined clock signal, a drain of the eighth transistor is coupled to the second terminal of the second capacitor, and a source of the eighth transistor is coupled to the reference level.

According to an exemplary embodiment of the invention, the first through the eighth transistors are N-type transistors.

According to an exemplary embodiment of the invention, enabling periods of the first start pulse signal and the second start pulse signal are partially overlapped with each other, the first predetermined clock signal and the second predetermined clock signal are complementary, and enabling periods of the second through the fourth predetermined clock signals are partially overlapped with each other.

The invention further provides a liquid crystal display, which includes a liquid crystal display panel and a backlight module for providing a light source to the liquid crystal display panel. Wherein, the liquid crystal display panel includes a substrate and the shift register device described above, where the aforementioned shift register device is directly disposed on the substrate of the liquid crystal display panel.

It should be understood that both the foregoing general description and the following detailed description are exemplary, and are intended to provide further explanation of the invention as claimed without limiting the scope or the spirit of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system block diagram illustrating a liquid crystal display 100 according to an exemplary embodiment of the invention.

FIG. 2 is a block diagram illustrating a shift register device SRD according to an exemplary embodiment of the invention.

FIG. 3A is a block diagram illustrating an implementation of an i^{th} shift register SRᵢ in FIG. 2.

FIG. 3B is a circuit diagram illustrating an implementation of an i^{th} shift register SRᵢ in FIG. 3A.

FIG. 4 is an operational timing diagram illustrating the first shift register according to an exemplary embodiment of the invention.

FIG. 5 is a logic equivalent circuit diagram illustrating an operation of a trimming circuit 203 in FIG. 3B.

### DESCRIPTION OF THE EMBODIMENTS

Descriptions of the invention are given with reference to the exemplary embodiments illustrated with accompanied drawings, wherein same or similar parts are denoted with same reference numerals. In addition, whenever possible, identical or similar reference numbers stand for identical or similar elements in the figures and the embodiments.

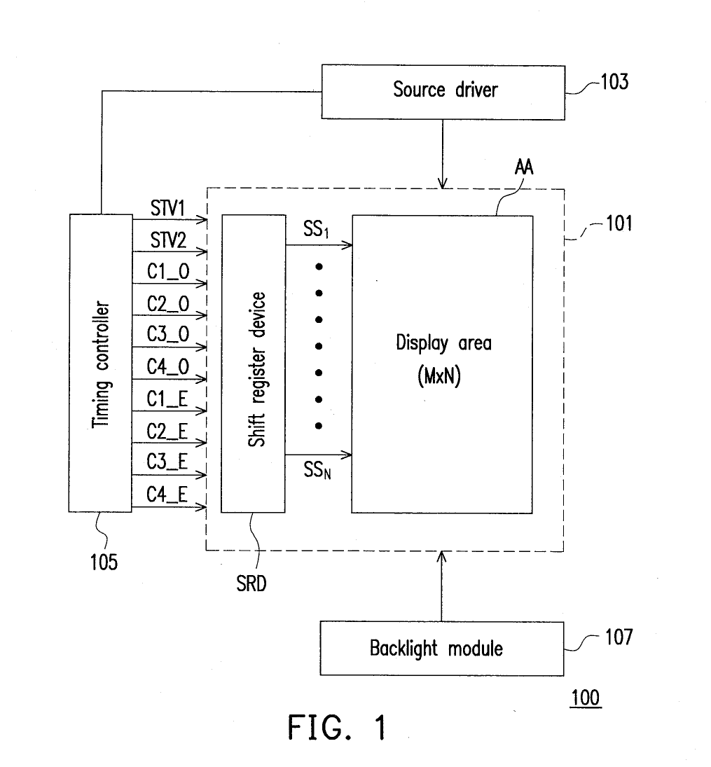

FIG. 1 is a system block diagram illustrating a liquid crystal display (LCD) 100 according to an exemplary embodiment of the invention. Referring to FIG. 1, the liquid crystal display 100 includes a liquid crystal display panel 101, a source driver 103, a timing controller (T-con) 105 and a backlight module 107 for providing a light source (i.e. backlight source) to the liquid crystal display panel 101.

In the exemplary embodiment, a display area AA of the liquid crystal display panel 101 has a plurality of pixels arranged in array, which is represented in M*N in FIG. 1, where M and N are both positive integers. Generally, the display resolution of the liquid crystal display 100 may also be represented in M*N, such as 1024*768, however, the invention is not limited thereto.

Moreover, a shift register device SRD may further be directly disposed on a side of a substrate (not shown, such as a glass substrate) of the liquid crystal display panel 101. The shift register device SRD is controlled by the timing controller 105, and sequentially outputs N scan signals SS₁˜SS_{N} in response to a first start pulse signal STV1, a second start pulse signal STV2 and clock signals (C1_O˜C4_O, C1_E˜C4_E) provided by the timing controller 105, so as to turn on pixel rows one-by-one in the display area AA, i.e. from the first pixel row to the last pixel row.

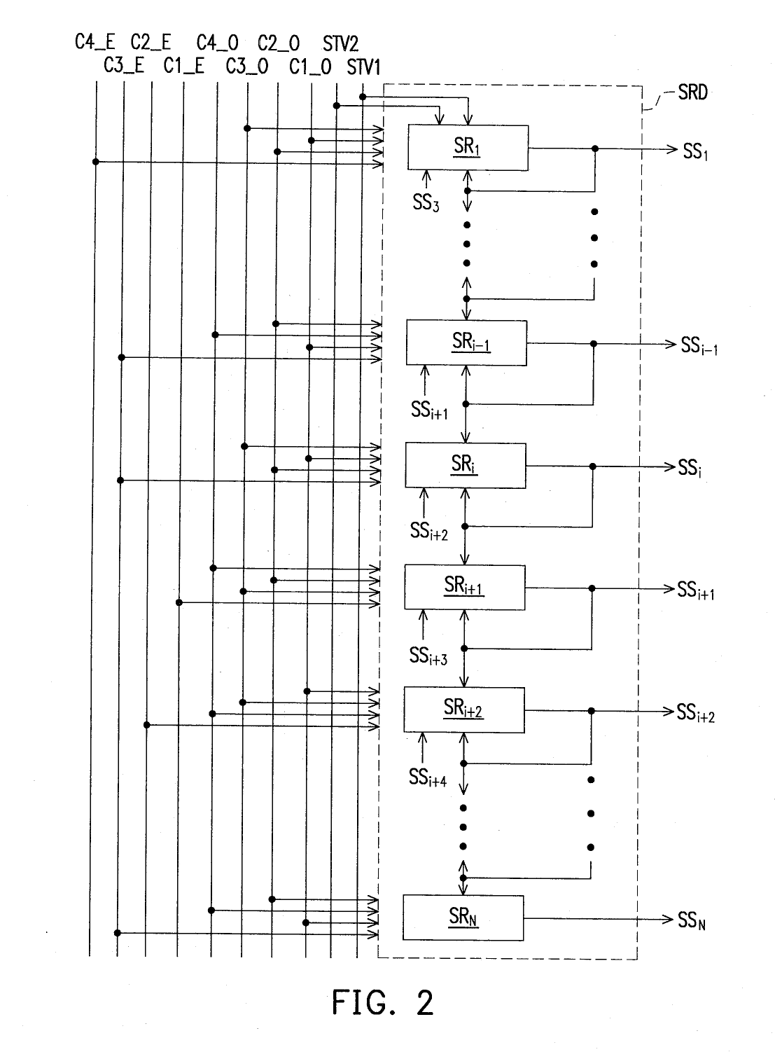

More specifically, FIG. 2 is a block diagram illustrating a shift register device SRD in FIG. 1. Referring to FIG. 1 and FIG. 2 together, the shift register device SRD includes N shift registers SR₁˜SR_{N} having substantially the same circuit configurations, and the shift registers SR₁˜SR_{N} are connected in series. Since the circuit configurations and the operation of the shift registers SR₁˜SR_{N} are substantially the same, only the i^{th} shift register SRᵢ (i=1˜N) is described in the following description.

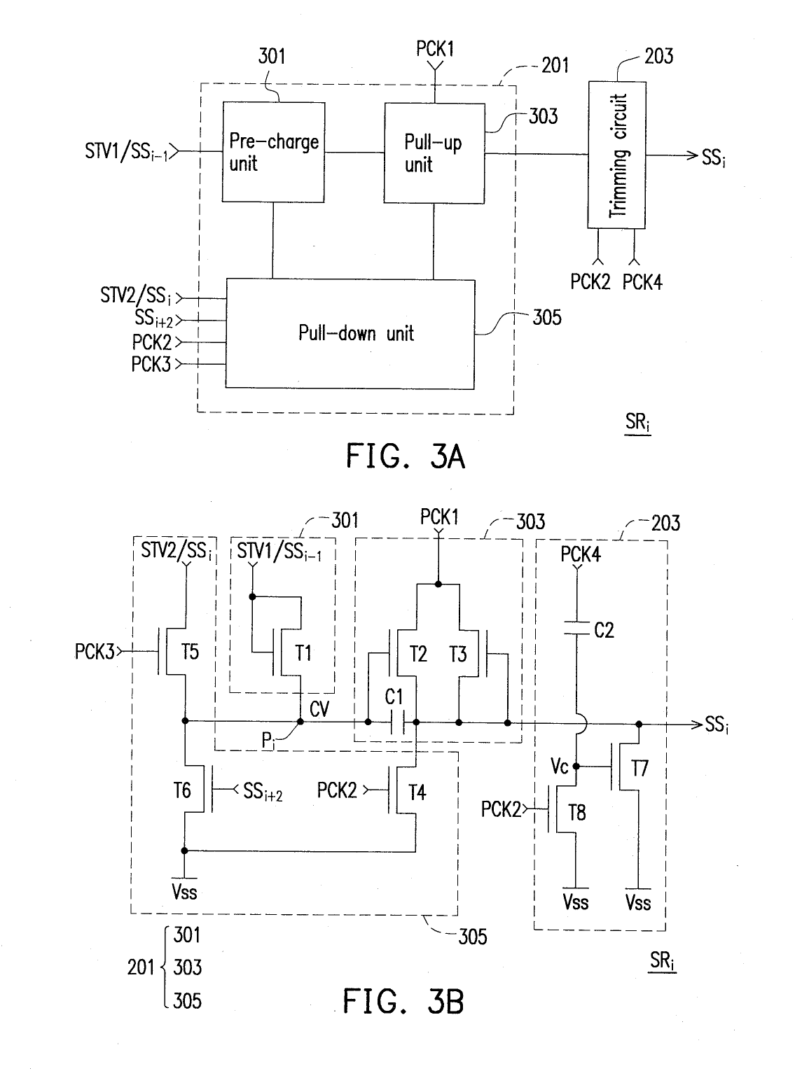

FIG. 3A is a block diagram illustrating an implementation of an i^{th} shift register SRᵢ in FIG. 2, and FIG. 3B is a circuit diagram illustrating an implementation of an i^{th} shift register SRᵢ in FIG. 3A. Referring to FIG. 1 through FIG. 3B together, the i^{th} shift register SRᵢ includes a main circuit 201 and a trimming circuit 203. The main circuit 201 is configured to generate the scan signal SSᵢ in response to a first through a third predetermined clock signals PCK1˜PCK3 from the timing controller 105. The trimming circuit 203 is coupled to the main circuit 201, and is configured to perform a trimming operation on the scan signal SSᵢ in response to a part of the first through the third predetermined clock signals PCK1˜PCK3 (namely, the second predetermined clock signal PCK2) and a fourth predetermined clock signal PCK4 from the timing controller 105.

In the exemplary embodiment, the main circuit 201 includes a pre-charge unit 301, a pull-up unit 303 and a pull-down unit 305. The pre-charge unit 301 is configured to receive the first start pulse signal STV1 from the timing controller 105 (under the condition of i=1) or an output SSᵢ₋₁ of an (i−1)^{th} shift register (under the condition of i=2˜N), and accordingly output a charge signal CV.

For example, the pre-charge unit 301 in the first shift register SR₁ receives the first start pulse signal STV1 from the timing controller 105; the pre-charge unit 301 in the second shift register SR₂ receives the scan signal SS₁ outputted by the first shift register SR₁; the pre-charge unit 301 in the third shift register SR₃ receives the scan signal SS₂ outputted by the second shift register SR₂; and continue the operation analogically for the rest until the pre-charge unit 301 in the N^{th} shift register SR_{N} receives the scan signal SS_{N-1} outputted by the (N−1)^{th} shift register SR_{N-1}.

Moreover, the pull-up unit 303 is coupled to the pre-charge unit 301, and is configured to receive the charge signal CV from the pre-charge unit 301 and the first predetermined clock signal PCK1 from the timing controller 105, and accordingly output the scan signal SSᵢ. Furthermore, the pull-down unit 305 is coupled to the pre-charge unit 301, the pull-up unit 303 and the trimming circuit 203, and is configured to receive the second and the third predetermined clock signals (PCK2, PCK3) from the timing controller 105, the output SSᵢ₊₂ of the (i+2)^{th} shift register SRᵢ₊₂ and one of the scan signal SSᵢ outputted by the i^{th} shift register SRᵢ and the second start pulse signal STV2 (under the condition of i=1), and accordingly determine whether to pull down the scan signal SSᵢ outputted by the i^{th} shift register SRᵢ to a reference level Vss (such as a negative voltage, however, the invention is not limited thereto).

More specifically, as shown in FIG. 3B, the pre-charge unit 301 includes a first transistor T1. The first transistor T1 may be an N-type transistor, however, the invention is not limited thereto. A gate and a drain of the first transistor T1 are coupled with each other to receive the first start pulse signal STV1 (under the condition of i=1) or the output (namely, the scan signal SSᵢ₋₁) of the (i−1)^{th} shift register SRᵢ₋₁ (under the condition of i=2˜N), and a source of the first transistor T1 outputs the charge signal CV.

Moreover, the pull-up unit 303 includes a second transistor T2, a third transistor T3 and a first capacitor C1. The second and the third transistors T2, T3 may also be N-type transistors, however, the invention is not limited thereto. A gate of the second transistor T2 is coupled to the source of the first transistor T1, a drain of the second transistor T2 receives the first predetermined clock signal PCK1 from the timing controller 105, and a source of the second transistor T2 outputs the scan signal SSᵢ. A gate and a source of the third transistor T3 are coupled to the source of the second transistor T2, and a drain electrode of the third transistor T3 receives the first predetermined clock signal PCK1 from the timing controller 105. The first capacitor C1 is coupled between the gate and the source of the second transistor T2.

Furthermore, the pull-down unit 305 includes a fourth transistor T4, a fifth transistor T5 and a sixth transistor T6. The fourth through the sixth transistors T4˜T6 may also be N-type transistors, however, the invention is not limited thereto. A gate of the fourth transistor T4 receives the second predetermined clock signal PCK2 from the timing controller 105, a drain of the fourth transistor T4 is coupled to the source of the second transistor T2, and a source of the fourth transistor T4 is coupled to the reference level Vss. A gate of the fifth transistor T5 receives the third predetermined clock signal PCK3 from the timing controller 105, a drain of the fifth transistor T5 receives the second start pulse signal STV2 (under the condition of i=1) or the scan signal SSᵢ outputted by the i^{th} shift register SRᵢ, and a source of the fifth transistor T5 is coupled to the source of the first transistor T1. A gate of the sixth transistor T6 receives the scan signal SSᵢ₊₂ outputted by the (i+2)^{th} shift register SRᵢ₊₂, a drain of the sixth transistor T6 is coupled to the source of the first transistor T1, and a source of the sixth transistor T6 is coupled to the reference level Vss.

Besides, in the exemplary embodiment, the trimming circuit 203 includes a second capacitor C2, a seventh transistor T7 and an eighth transistor T8. The seventh and the eighth transistors T7, T8 may also be N-type transistors, however, the invention is not limited thereto. A first terminal of the second capacitor C2 receives the fourth predetermined clock signal PCK4 from the timing controller 105. A gate of the seventh transistor T7 is coupled to a second terminal of the second capacitor C2, a drain of the seventh transistor T7 is coupled to the source of the second transistor T2, and a source of the seventh transistor T7 is coupled to the reference level Vss. A gate of the eighth transistor T8 receives the second predetermined clock signal PCK2 from the timing controller 105, a drain of the eighth transistor T8 is coupled to the second terminal of the second capacitor C2, and a source of the eighth transistor T8 is coupled to the reference level Vss.

Based on the above, the first shift register SRᵢ (i=1) is exemplified herein, the first predetermined clock signal PCK1 received by the drains of the second and the third transistors T2, T3 in the pull-up unit 303 is the clock signal C3_O; the second and the third predetermined clock signals (PCK2, PCK3) received respectively by the gates of the fourth and the fifth transistors T4, T5 in the pull-down unit 305 are the clock signals C1_O and C2_O respectively; and the second and the fourth predetermined clock signals (PCK2, PCK4) received respectively by the gate of the eighth transistor T8 and the first terminal of the second capacitor C2 in the trimming circuit 203 are the clock signals C1_O and C4_E respectively.

The second shift register SRᵢ (i=2) is exemplified herein, the first predetermined clock signal PCK1 received by the drains of the second and the third transistors T2, T3 in the pull-up unit 303 is the clock signal C4_O; the second and the third predetermined clock signals (PCK2, PCK3) received respectively by the gates of the fourth and the fifth transistors T4, T5 in the pull-down unit 305 are the clock signals C2_O and C3_O respectively; and the second and the fourth predetermined clock signals (PCK2, PCK4) received respectively by the gate of the eighth transistor T8 and the first terminal of the second capacitor C2 in the trimming circuit 203 are the clock signals C2_O and C1_E respectively.

The third shift register SRᵢ (i=3) is exemplified herein, the first predetermined clock signal PCK1 received by the drains of the second and the third transistors T2, T3 in the pull-up unit 303 is the clock signal C1_O; the second and the third predetermined clock signals (PCK2, PCK3) received respectively by the gates of the fourth and the fifth transistors T4, T5 in the pull-down unit 305 are the clock signals C3_O and C4_O respectively; and the second and the fourth predetermined clock signals (PCK2, PCK4) received respectively by the gate of the eighth transistor T8 and the first terminal of the second capacitor C2 in the trimming circuit 203 are the clock signals C3_O and C2_E respectively.

The fourth shift register SRᵢ (i=4) is exemplified herein, the first predetermined clock signal PCK1 received by the drains of the second and the third transistors T2, T3 in the pull-up unit 303 is the clock signal C2_O; the second and the third predetermined clock signals (PCK2, PCK3) received respectively by the gates of the fourth and the fifth transistors T4, T5 in the pull-down unit 305 are the clock signals C4_O and C1_O respectively; and the second and the fourth predetermined clock signals (PCK2, PCK4) received respectively by the gate of the eighth transistor T8 and the first terminal of the second capacitor C2 in the trimming circuit 203 are the clock signals C4_O and C3_E respectively.

The fifth shift register SRᵢ (i=5) is exemplified herein, the first predetermined clock signal PCK1 received by the drains of the second and the third transistors T2, T3 in the pull-up unit 303 is the clock signal C3_O; the second and the third predetermined clock signals (PCK2, PCK3) received respectively by the gates of the fourth and the fifth transistors T4, T5 in the pull-down unit 305 are the clock signals C1_O and C2_O respectively; and the second and the fourth predetermined clock signals (PCK2, PCK4) received respectively by the gate of the eighth transistor T8 and the first terminal of the second capacitor C2 in the trimming circuit 203 are the clock signals C1_O and C4_E respectively.

The sixth shift register SRᵢ (i=6) is exemplified herein, the first predetermined clock signal PCK1 received by the drains of the second and the third transistors T2, T3 in the pull-up unit 303 is the clock signal C4_O; the second and the third predetermined clock signals (PCK2, PCK3) received respectively by the gates of the fourth and the fifth transistors T4, T5 in the pull-down unit 305 are the clock signals C2_O and C3_O respectively; and the second and the fourth predetermined clock signals (PCK2, PCK4) received respectively by the gate of the eighth transistor T8 and the first terminal of the second capacitor C2 in the trimming circuit 203 are the clock signals C2_O and C1_E respectively.

The seventh shift register SRᵢ (i=7) is exemplified herein, the first predetermined clock signal PCK1 received by the drains of the second and the third transistors T2, T3 in the pull-up unit 303 is the clock signal C1_O; the second and the third predetermined clock signals (PCK2, PCK3) received respectively by the gates of the fourth and the fifth transistors T4, T5 in the pull-down unit 305 are the clock signals C3_O and C4_O respectively; and the second and the fourth predetermined clock signals (PCK2, PCK4) received respectively by the gate of the eighth transistor T8 and the first terminal of the second capacitor C2 in the trimming circuit 203 are the clock signals C3_O and C2_E respectively.

The eighth shift register SRᵢ (i=8) is exemplified herein, the first predetermined clock signal PCK1 received by the drains of the second and the third transistors T2, T3 in the pull-up unit 303 is the clock signal C2_O; the second and the third predetermined clock signals (PCK2, PCK3) received respectively by the gates of the fourth and the fifth transistors T4, T5 in the pull-down unit 305 are the clock signals C4_O and C1_O respectively; and the second and the fourth predetermined clock signals (PCK2, PCK4) received respectively by the gate of the eighth transistor T8 and the first terminal of the second capacitor C2 in the trimming circuit 203 are the clock signals C4_O and C3_E respectively.

It can be seen that, every four shift registers in the shift register device SRD, from up to down, may be regarded to be in the same group, such as SR_{1˜4}, SR_{5˜8}, . . . , SR_{N-3˜N}. The first predetermined clock signals PCK1 received respectively by the drains of the transistors (T2, T3) of the four shift registers in the same group (SR_{1˜4}, SR_{5˜8}, . . . , SR_{N-3˜N}) are sequentially the clock signals C3_O→C4_O→C1_O→C2_O; the second predetermined clock signals PCK2 received respectively by the gates of the transistors (T4, T8) of the four shift registers in the same group (SR_{1˜4}, SR_{5˜8}, . . . , SR_{N-3˜N}) are sequentially the clock signals C1_O→C2_O→C3_O→C4_O; the third predetermined clock signals PCK3 received respectively by the gates of the transistors (T5) of the four shift registers in the same group (SR_{1˜4}, SR_{5˜8}, . . . , SR_{N-3˜N}) are sequentially the clock signals C2_O→C3_O→C4_O→C1_O; and the fourth predetermined clock signals PCK4 received respectively by the first terminals of the capacitors (C2) of the four shift registers in the same group (SR_{1˜4}, SR_{5˜8}, . . . , SR_{N-3˜N}) are sequentially the clock signals C4_E→C1_E→C2_E→C3_E.

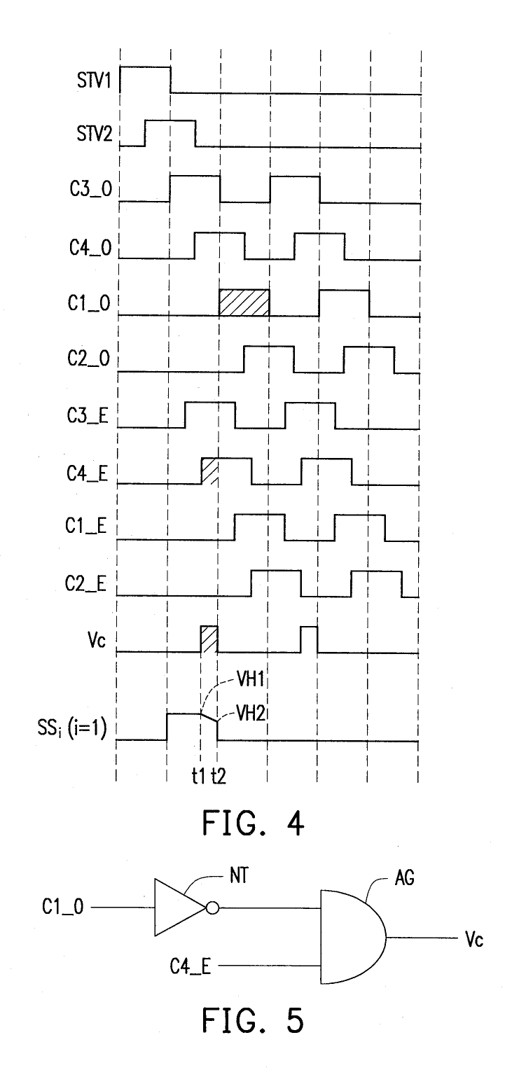

Herein, in order to further describe the operation of each of the shift registers SR_{1˜N}, FIG. 4 is an operational timing diagram illustrating the i^{th} shift register SRᵢ in FIG. 3B. Referring to FIG. 4, it can be seen from FIG. 4 that, the timing controller 105 may sequentially and periodically generate the clock signals C3_O, C4_O, C1_O and C2_O to the shift register device SRD, and the enabling periods of the sequentially generated clock signals C3_O, C4_O, C1_O and C2_O are partially overlapped with each other such as 50% overlapping (namely, the phase difference is 90°). However, the invention is not limited thereto. The clock signals (C3_O, C1_O) and the clock signals (C4_O, C2_O) are complementary (namely, the phase difference is 180°).

In other words, the enabling periods of the clock signals C3_O and C4_O are 50% overlapped; the enabling periods of the clock signals C4_O and C1_O are 50% overlapped; the enabling periods of the clock signals C1_O and C2_O are 50% overlapped; the enabling periods of the clock signals C2_O and C3_O are 50% overlapped; the enabling periods of the clock signals C3_O and C1_O are not overlapped; and the enabling periods of the clock signals C4_O and C2_O are not overlapped.

Moreover, the timing controller 105 may generate the first and the second start pulse signals STV1, STV2 to the shift register device SRD (under the condition of i=1), and the enabling periods of the generated first and second start pulse signals STV1, STV2 are partially overlapped with each other such as 50% overlapping (namely, the phase difference is 90°). However, the invention is not limited thereto. Furthermore, the enabling period of the second start pulse signal STV2 and the initial enabling period of the clock signal C3_O, both generated by the timing controller 105, are 50% overlapped (namely, the phase difference is 90°).

In addition, the timing controller 105 may also sequentially and periodically generate the clock signals C3_E, C4_E, C1_E and C2_E to the shift register device SRD, the enabling periods of the sequentially generated clock signals C3_E, C4_E, C_E and C2_E are partially overlapped with each other such as 50% overlapping (namely, the phase difference is 90°). However, the invention is not limited thereto. The clock signals (C3_E, C1_E) and the clock signals (C4_E, C2_E) are complementary (namely, the phase difference is 180°).

In other words, the enabling periods of the clock signals C3_E and C4_E are 50% overlapped; the enabling periods of the clock signals C4_E and C1_E are 50% overlapped; the enabling periods of the clock signals C1_E and C2_E are 50% overlapped; the enabling periods of the clock signals C2_E and C3_E are 50% overlapped; the enabling periods of the clock signals C3_E and C1_E are not overlapped; and the enabling periods of the clock signals C4_E and C2_E are not overlapped.

Herein, it should be noted that, the phase difference between the clock signals C3_O and C3_E is 45° (namely, the enabling periods of the clock signals C3_O and C3_E are 75% overlapped); the phase difference between the clock signals C4_O and C4_E is 45° (namely, the enabling periods of the clock signals C4_O and C4_E are 75% overlapped); the phase difference between the clock signals C1_O and C1_E is 45° (namely, the enabling periods of the clock signals C1_O and C1_E are 75% overlapped); and the phase difference between the clock signals C2_O and C2_E is 45° (namely, the enabling periods of the clock signals C2_O and C2_E are 75% overlapped).

Under such condition, the first shift register SRᵢ (i=1) is exemplified herein. In the first shift register SR₁, the first predetermined clock signal PCK1 is the clock signal C3_O, the second predetermined clock signal PCK2 is the clock signal C1_O, the third predetermined clock signal PCK3 is the clock signal C2_O and the fourth predetermined clock signal PCK4 is the clock signal C4_E, therefore, the operation of the first shift register SR₁ is described in the following description.

Firstly, when the timing controller 105 provides the first start pulse signal STV1 to the pre-charge unit 301 in the first shift register SR₁, the pre-charge unit 301 may pre-charge a node P₁ (i=1) in response to the first start pulse signal STV1, so as to generate the charge signal CV at the node P₁ (i=1). In this way, when the clock signal C3_O provided by the timing controller 105 is enabled, the voltage at the node P₁ (i=1) may be pulled up due to the coupling effect of the clock signal C3_O, so as to turn on the second transistor T2 in the pull-up unit 303, thereby causing the third transistor T3 to turn on at the same time, so as to output the scan signal SS₁ (i=1) of the first shift register SR₁ (i=1).

During a certain period of the scan signal SS₁ (i=1) outputted by the first shift register SR₁ (i=1), such as time t1˜t2, the trimming circuit 203 may be activated in response to the clock signals C1_O and C4_E from the timing controller 105, so as to perform the trimming operation on the scan signal SS₁ (i=1) of the first shift register SR₁ (i=1), thereby reducing the feed through effect.

More specifically, in terms of operation, the circuit structure of the trimming circuit 203 illustrated in FIG. 3B may be equivalent to the logic circuit illustrated in FIG. 5, that is, the combination of a NOT gate NT and an AND gate AG. An input terminal of the NOT gate NT receives the clock signal C1_O from the timing controller 105, and an output terminal of the NOT gate NT is coupled to a first input terminal of the AND gate AG. A second input terminal of the AND gate AG receives the clock signal C4_E from the timing controller 105, and an output terminal of the AND gate AG generates a trimming signal Vc.

Based on the above, the trimming circuit 203 may only generate a high-level trimming signal Vc under the circumstance that the clock signal C1_O is low-level and the clock signal C4_E is high-level. Therefore, during the certain period of the scan signal SS₁ (i=1) outputted by the first shift register SR₁ (i=1), i.e. time t1˜t2, the seventh transistor T7 in the trimming circuit 203 may be turned on during the time t1˜t2 in response to the high-level trimming signal Vc, so as to pull down the original high-level VH1 of the scan signal SS₁ (i=1) of the first shift register SR₁ (i=1) to a predetermined high-level VH2 (which is between the high-level VH1 and the reference level Vss, namely, Vss<VH2<VH1), thereby achieving to perform the trimming operation on the scan signal SS₁ (i=1) of the first shift register SR₁ (i=1).

In the exemplary embodiment, the quantity/magnitude of the voltage difference ΔV (namely, the feed-through voltage) pulled down by the effect of parasitic capacitance between the electrodes in the active element for each pixel in the display area AA, may be changed by adjusting the size of the seventh transistor T7. Furthermore, the voltage value of the trimming signal Vc may also be changed by adjusting the capacitance value of the second capacitor C2 and the size of the eighth transistor T8.

On the other hand, after the pre-charge unit 301 and the pull-up unit 303 collaboratively output the scan signal SS₁ (i=1) and the trimming circuit 203 is in charge of trimming the scan signal SS₁ (i=1), the pull-down unit 305 is in charge of pulling down the scan signal SS₁ (i=1) to the reference level Vss in response to the clock signal C1_O, the clock signal C2_O, the output (namely, the scan signal SS₃) of the next two stages shift register SRᵢ₊₂ (namely, SR₃) and the second start pulse signal STV2/the scan signal SS₁ (under the condition of i=1).

More specifically, the fourth transistor T4 in the pull-down unit 305 may be turned on in response to the enablement of the clock signal C1_O from the timing controller 105, so as to pull down the high-level VH2 of the trimmed scan signal SS₁ (i=1) to the reference level Vss. In addition, the fifth and the sixth transistors T5, T6 in the pull-down unit 305 may be turned on in response to the enabled clock signal C2_O and the enabled scan signal SS₃ of the third shift register SR₃, respectively, so as to prevent the second transistor T2 in the pull-up unit 303 being mistakenly turned on due to the coupling effect of the clock signal C3_O.

Moreover, after the time t2, the fourth transistor T4 in the pull-down unit 305 may be turned on periodically in response to the clock signal C1_O from the timing controller 105, and the trimming circuit 203 may also generate the high-level trimming signal Vc periodically under the circumstance that the clock signal C1_O is low-level and the clock signal C4_E is high-level. In this way, the seventh transistor T7 in the trimming circuit 203 may be collaborated with the fourth transistor T4 in the pull-down unit 305 to maintain the low-level scan signal SS₁ (i=1) being pulled-down at the reference level Vss persistently.

Herein, although the aforementioned exemplary embodiments are based on the operation of the first shift register SR₁, the operations of the rest shift registers SR_{2˜N} are similar to the first shift register SR₁, and thus detailed description thereof will be omitted.

Accordingly, when the timing controller 105 provides the first and the second start pulse signals STV1, STV2 to the first shift register SR₁, and respectively provides the corresponding four signals of the clock signals (C1_O˜C4_O) and (C1_E˜C4_E) to the shift registers SR₁˜SR_{N}, the shift registers SR₁˜SR_{N} in the shift register device SRD may sequentially output the trimmed scan signals SS₁˜SS_{N} to turn on the pixel rows one-by-one in the display area AA, i.e. from the first pixel row to the last pixel row. The source driver 103 may provide the corresponding display data to the pixel rows turned on by the shift register device SRD. In this way, the liquid crystal display panel 101 is capable of displaying image frames, with the light source (backlight) provided by the backlight module 107. Wherein, the backlight module 107 may be a cold cathode fluorescent lamp (CCFL) backlight module or a light emitting diode (LED) backlight module, however, the invention is not limited thereto.

According to the above descriptions, in the invention, the shift register device may sequentially output a plurality of trimmed scan signals, so as to turn on a plurality of pixel rows one-by-one in the liquid crystal display panel. In this way, the voltage on the common electrode of the entire liquid crystal display panel (namely, the common voltage Vcom) may be uniformed, so as to effectively solve the issue of the flickers generated on the liquid crystal display panel, thereby improving the display quality of the liquid crystal display. Besides, the shift register device may be directly disposed on the glass substrate of the liquid crystal display panel, and each shift register of the shift register device includes the trimming circuit to perform the trimming operation on the corresponding scan signal, therefore, there is no need to re-exploit a special gate driver chip, thereby reducing the research time and the manufacturing cost for products.

On the other hand, under the condition that the manufacturing factors are permitted, each shift register in the aforementioned exemplary embodiments may further be constituted by P-type transistors. In other words, it is a complementary circuit structure of FIG. 3B, and such modified exemplary embodiments would fall in the scope of the claimed invention.

In addition, although the trimming circuit in the aforementioned exemplary embodiments is applied to a certain circuit implementation form of the pre-charge unit, the pull-up unit and the pull-down unit, however, the invention is not limited thereto. In other words, as long as the shift register may be divided into other circuit implementation forms of the pre-charge unit, the pull-up unit and the pull-down unit, the trimming circuit of the invention may be adapted thereof, and such modified exemplary embodiments would fall in the scope of the claimed invention.

Furthermore, it will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A shift register device, comprising:
a plurality of shift registers connected in series, wherein an i^{th} shift register comprises:
a main circuit, configured to generate a scan signal in response to a first through a third predetermined clock signals; and
a trimming circuit, coupled to the main circuit, and configured to perform a trimming operation on the scan signal in response to a part of the first through the third predetermined clock signals and a fourth predetermined clock signal, where i is a positive integer.

2. The shift register device as claimed in claim 1, wherein the main circuit of the i^{th} shift register comprises:
a pre-charge unit, configured to receive a first start pulse signal or output of an (i−1)^{th} shift register, and accordingly output a charge signal;
a pull-up unit, coupled to the pre-charge unit, and configured to receive the charge signal and the first predetermined clock signal, and accordingly output the scan signal; and
a pull-down unit, coupled to the pre-charge unit, the pull-up unit and the trimming circuit, and configured to receive the second predetermined clock signal, the third predetermined clock signal, output of an (i+2)^{th} shift register and one of a second start pulse signal and the scan signal, and accordingly determine whether to pull down the scan signal to a reference level.

3. The shift register device as claimed in claim 2, wherein the pre-charge unit comprises:
a first transistor, having a gate and a drain coupled with each other to receive the first start pulse signal or the output of the (i−1)^{th} shift register, and a source outputting the charge signal.

4. The shift register device as claimed in claim 3, wherein the pull-up unit comprises:
a second transistor, having a gate coupled to the source of the first transistor, a drain receiving the first predetermined clock signal, and a source outputting the scan signal;
a third transistor, having a gate and a source coupled to the source of the second transistor, and a drain receiving the first predetermined clock signal; and
a first capacitor, coupled between the gate and the source of the second transistor.

5. The shift register device as claimed in claim 4, wherein the pull-down unit comprises:
a fourth transistor, having a gate receiving the second predetermined clock signal, a drain coupled to the source of the second transistor, and a source coupled to the reference level;
a fifth transistor, having a gate receiving the third predetermined clock signal, a drain receiving the second start pulse signal or the scan signal, and a source coupled to the source of the first transistor; and
a sixth transistor, having a gate receiving the output of the (i+2)^{th} shift register, a drain coupled to the source of the first transistor, and a source coupled to the reference level.

6. The shift register device as claimed in claim 5, wherein the trimming circuit comprises:
a second capacitor, having a first terminal receiving the fourth predetermined clock signal;
a seventh transistor, having a gate coupled to a second terminal of the second capacitor, a drain coupled to the source of the second transistor, and a source coupled to the reference level; and
an eighth transistor, having a gate receiving the second predetermined clock signal, a drain coupled to the second terminal of the second capacitor, and a source coupled to the reference level.

7. The shift register device as claimed in claim 6, wherein the first through the eighth transistors are N-type transistors.

8. The shift register device as claimed in claim 1, wherein:
enabling periods of the first start pulse signal and the second start pulse signal are partially overlapped with each other;
the first predetermined clock signal and the second predetermined clock signal are complementary; and
enabling periods of the second through the fourth predetermined clock signals are partially overlapped with each other.

9. A liquid crystal display, comprising:
a liquid crystal display panel, at least comprising a substrate and a shift register device, where the shift register device having a plurality of shift registers connected in series is directly disposed on the substrate, wherein an i^{th} shift register comprises:
a main circuit, configured to generate a scan signal in response to a first through a third predetermined clock signals; and
a trimming circuit, coupled to the main circuit, and configured to perform a trimming operation on the scan signal in response to a part of the first through the third predetermined clock signals and a fourth predetermined clock signal, where i is a positive integer; and
a backlight module, providing a light source to the liquid crystal display panel.

10. The liquid crystal display as claimed in claim 9, wherein the main circuit of the i^{th} shift register comprises:
a pre-charge unit, configured to receive a first start pulse signal or output of an (i−1)^{th} shift register, and accordingly output a charge signal;
a pull-up unit, coupled to the pre-charge unit, and configured to receive the charge signal and the first predetermined clock signal, and accordingly output the scan signal; and
a pull-down unit, coupled to the pre-charge unit, the pull-up unit and the trimming circuit, and configured to receive the second predetermined clock signal, the third predetermined clock signal, output of an (i+2)^{th} shift register and one of a second start pulse signal and the scan signal, and accordingly determine whether to pull down the scan signal to a reference level.

11. The liquid crystal display as claimed in claim 10, wherein the pre-charge unit comprises:
a first transistor, having a gate and a drain electrode coupled with each other to receive the first start pulse signal or the output of the (i−1)^{th} shift register, and a source electrode outputting the charge signal.

12. The liquid crystal display as claimed in claim 11, wherein the pull-up unit comprises:
a second transistor, having a gate coupled to the source of the first transistor, a drain receiving the first predetermined clock signal, and a source outputting the scan signal;
a third transistor, having a gate and a source coupled to the source of the second transistor, and a drain receiving the first predetermined clock signal; and
a first capacitor, coupled between the gate and the source of the second transistor.

13. The liquid crystal display as claimed in claim 12, wherein the pull-down unit comprises:
a fourth transistor, having a gate receiving the second predetermined clock signal, a drain coupled to the source of the second transistor, and a source coupled to the reference level;
a fifth transistor, having a gate receiving the third predetermined clock signal, a drain receiving the second start pulse signal or the scan signal, and a source coupled to the source of the first transistor; and
a sixth transistor, having a gate receiving the output of the (i+2)^{th} shift register, a drain coupled to the source of the first transistor, and a source coupled to the reference level.

14. The liquid crystal display as claimed in claim 13, wherein the trimming circuit comprises:
a second capacitor, having a first terminal receiving the fourth predetermined clock signal;
a seventh transistor, having a gate coupled to a second terminal of the second capacitor, a drain coupled to the source of the second transistor, and a source coupled to the reference level; and
an eighth transistor, having a gate receiving the second predetermined clock signal, a drain coupled to the second terminal of the second capacitor, and a source coupled to the reference level.

15. The liquid crystal display as claimed in claim 14, wherein the first through the eighth transistors are N-type transistors.

16. The liquid crystal display as claimed in claim 9, wherein:
enabling periods of the first start pulse signal and the second start pulse signal are partially overlapped with each other;
the first predetermined clock signal and the second predetermined clock signal are complementary; and
enabling periods of the second through the fourth predetermined clock signals are partially overlapped with each other.
